(19) United States
(12) Patent Application Publication
(10) Pub. No.: US 2012/0027943 A1
(43) Pub. Date: Feb. 2, 2012

(54) METHOD FOR FORMING A THREE-DIMENSIONAL POLYMER BASE

(76) Inventor: Miguel A. Linares, Bloomfield Hills, MI (US)

(21) Appl. No.: 13/269,648

(22) Filed: Oct. 10, 2011

Related U.S. Application Data
(62) Division of application No. 12/703,229, filed on Feb. 10, 2010.
Application No. 12/703,229 is a division of application No. 11/326,632, filed on Jan. 6, 2006, now abandoned.
Application No. 11/326,632 is a continuation-in-part of application No. 10/413,886, filed on Apr. 15, 2003, now abandoned.
(60) Provisional application No. 60/374,771, filed on Apr. 24, 2002.
(60) Provisional application No. 60/413,139, filed on Sep. 25, 2002.

(51) Int. Cl. B05D 1/24

(52) U.S. Cl. 427/459

(57) ABSTRACT

An apparatus and related method for forming a three-dimensional polymer based part including a die tool having a specified shape and size and exhibiting an exposed polymer adhering surface corresponding in configuration to a polymeric based part to be created. A volume holding bin supports a three-dimensional article including at least one exposed and pattern defining surface. A volume of a granulated polymer material is deposited into the bin and around the article. A sub-volume of the material adheres to and forms a hardened layer upon the exposed pattern defining surface, a corresponding part created having a specified thickness and matching configuration.

### CROSS REFERENCE TO RELATED APPLICATIONS

The present application is a divisional application of U.S. patent application Ser. No. 12/703,229 filed Feb. 10, 2010, which in turn is a divisional application of U.S. patent application Ser. No. 11/326,632, filed Jan. 6, 2006, which is a continuation-in-part of U.S. patent application Ser. No. 10/413,886, filed Apr. 15, 2003, which in turn claims the benefit of U.S. Provisional Application Ser. Nos. 60/374,771, filed Apr. 24, 2002, and 60/413,139, filed Sep. 25, 2002.

### BACKGROUND OF THE INVENTION

1. Field of the Invention

The present invention relates generally to an apparatus and associated method for aggregating a plasticized resin or composite in a drawing process through the application of heat. More particularly, the present invention discloses a drawing process and assembly for creating a plasticized part, using a heated tool communicated with a bin filled with a resinous material, such as in pellet or aggregate form. The present invention also discloses a related process for coating a heated and electrostatically charged metallic member drawn in continuous fashion through a like bin of resinous material.

2. Description of the Prior Art

The prior art is well documented with various examples of article forming assemblies and methods and which in particular incorporate the use of heated and/or compression technology and in which to form a three-dimensional resin based article. The objective in each instance is to create a plasticized/resinous based article in a desired time and cost efficient basis.

General examples drawn from the prior art include U.S. Pat. No. 5,073,329, issued from Carrara, and which teaches an apparatus and method for forming seals, such as composite seals in rubber/metal or other materials, and which includes supplying a raw elastomeric mixture in the form of a suitably shaped extrusion. A transfer machine with a plurality of carriers is provided, each having hinged mold halves defining a mold cavity therebetween, a volume of a blank of raw elastomeric material being deposited on a first and opened mold half. The mold halves are closed and the blank of raw material both compressed and heated to form the desired finished product and as is defined by the specified mold cavity.

U.S. Pat. No. 3,679,342, issued to Fougeray et al., teaches a dipping from for making a skin type article, such as a raincoat, from a plastic material. According to this process, a hot former pattern is dipped into a fluidized bath of a powderized thermoplastic material, causing adhesion of the material. Portions of the former are coated with an adhesion preventative material, such as to provide neat edges and to avoid adhesion to buttonholes or other discontinuities in the article. This construction facilitates stripping of the peel-away plasticized layer from the former pattern.

U.S. Pat. No. 3,108,022, issued to Church, teaches an apparatus for coating an elongate body with a fluidized coating material. The fluidized bed includes orifices adapted to receive the elongate articles for passage through the bed below the upper level of the contained pulverulant coating material. Loss of coating material from these orifices is minimized by causing a significant quantity of gas to flow inwardly through the orifices to impede the flow of coating materials outwardly therethrough. The inward flow of gases through the submerged orifice is established by maintaining a lesser atmospheric pressure within the fluidized bed container and/or by directing a positive flow of gases into the interior of the container at a point adjacent the submerged orifices.

U.S. Pat. No. 3,600,753, issued to Otto, teaches a differential pressure forming mold wherein a sheet of deformable plastic is supported between a mold assembly having a plurality of article forming mold cavities and an opposed mold assembly having a plurality of cavity aligned, projecting plug assists. A plate is incorporated within the mold assembly, having the plug assists, and is operative to prevent ballooning of portions of the sheet surrounding those portions which are moved into the mold cavities by the plug assists and is mounted for relative movement with the plug assists. The plate is moved toward the mold assembly having the mold cavities to clamp the edges of the plastic sheet thereto, prior to the time the plug assists are moved into the cavities to stretch the sheet and mechanically move portions of the sheet into the mold cavities. Thereafter, a differential pressure condition is created to move the sheet portions finally into intimate engagement with the mold cavities.

U.S. Pat. No. 5,118,380, issued to Gatarz et al., teaches a rim flexible manufacturing insert for a molding press having an upper movable platen adapted to support a male mold member and a fixed lower platen adapted to support a female mold member. The molding press includes a mix head system and a hydraulic ejector system supported below the fixed lower platen. The manufacturing insert includes a table having a platen surface with legs depending downwardly therefrom, the legs being removably securable to the fixed lower platen of the molding press. The platen surface includes an enlarged opening therethrough and a mix head support system is supported below the platen surface intermediate the legs of the table. The mix head support system includes a mix head support and a slide system for permitting three-dimensional movement of the mix head from a first position where the mix head extends through the enlarged opening in the platen surface and to a second position where the mix head is beyond the upper platen.

U.S. Pat. No. 5,617,631, issued to Nguyen, teaches a method of making a liquid ink printhead orifice plate which includes the ink carrying features and a flat mandrel. Once the orifice plate has been stamped, excess material is removed from the orifice plate to reveal ink carrying features of the stamped orifice plate. The orifice plate mandrel is formed by electroforming a mandrel on an etched silicon wafer which defines a plurality of ink carrying channels and ink reservoirs. The electroform mandrel can be made of any number of metal which includes nickel.

U.S. Pat. No. 6,318,988, issued to Wrobbel, teaches a tool which enables articles to be deep drawn without difficulty, even when the material used is of low elasticity and/or when a decorative sheet is used to produce a composite article. The tool includes a die which has a recessed zone which extends between a die opening and die contour or an undercut. The recessed zone is delimited on one side at right angles to an end of the die and, in order to hold a decorative sheet in place, a mounting is fitted on a part of the recessed zone facing the end of the die.

### SUMMARY OF THE PRESENT INVENTION

The present invention discloses an apparatus and method for forming a three-dimensional and polymer based part. The apparatus includes including a die tool having a specified shape and size and exhibiting an exposed polymer adhering surface corresponding in configuration to a polymeric based part to be created.

In a first embodiment, a preheated die or tool surface is located within an open and volume holding interior, e.g. such as a bin, and which is subsequently filled with a polymer material, typically a synthetic plastic or the like, in a particulate form. The heated tool surface, exhibiting such as a metallic surface, is positioned within the bin such that the exposed and adhering surface is in contact with the particulate material. The heat conducted through the die tool causes a specified volume of the polymer material within the bin to aggregate upon the exposed surface of the die tool, the thickness of such aggregation typically being a variable of the time in which the tool is immersed by the subsequently applied particulate.

Upon completion of a desired aggregating/curing step, the bin is inverted, causing any remaining and non-aggregated particulate to be emptied, and such as upon a reconveying line for resupply to a hopper feed for reintroduction in a subsequent bin operation. The exposed and aggregated part is finally removed from the tool surface and finished according to any known trimming process. The plastic (thermoplastic) part formed upon the die tool is capable of being removed, such as by peeling off, when in the green or thermo-reacting stage and during which it is still flexible and easy to bend.

In a further preferred embodiment, the die tool is substituted by an elongated and structural member, typically a steel beam or reinforcing rod, and which is translated in axially extending fashion through a suitably constructed and configured bin of particulate filled material. Heat is again applied, typically to the beam, rod, etc., and prior to it being translated through the aggregate filled bin and the desired volume of particulate material adhered to the surface of the beam or rod.

As an additional feature, an electrical charge is introduced into the metallic/steel beam, the purpose of the electrical charge being to facilitate and to increase the attraction of the particulate material to the elongated structural member as it is drawn through the particulate filled bin. In order to maintain the particulate contents within the bin configured according to this embodiment, a vacuum pressure may be introduced within the bin interior and which, in conjunctive operation with the electrostatically charged surface of the workpiece member, facilitates application of a specified coating thickness. The surface of the structural steel member may further be coated with a rust-inhibiting material.

Also disclosed is a method of forming a three-dimensional polymer coating upon a die tool, the tool having a specified shape and size and exhibiting an exposed polymer adhering surface corresponding in configuration to a polymeric based part to be created. The method steps include pre-positioning the heated tool within the bin interior and subsequently pouring the plasticized/particulate material over the tool surface. Yet additional steps include adhering/curing, in a temperature and time based fashion, a desired volume and thickness of particulate to the tool surface, inverting the bin to expel remaining and non-aggregated amounts of particulate and, finally, peeling away the completed and hardening part created thereby.

Additional steps include applying a ceramic coating about an extending perimeter of the adhering surface of the tool and/or about at least one aperture defined in the die tool, and in order to prevent aggregating of material thereto. Other steps may include vibrating or shaking the bin during expelling or dumping of the unused particulate and which may simplify subsequent trimming or finishing operations.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a plan cutaway view of a die tool upon immersed within a volume of a subsequently introduced particulate material and upon which is adhered a three-dimensional volume of the resinous particulate according to a preferred embodiment of the present invention;

FIGS. 2a-2d are succeeding illustrations of the multi-stage process for adhering a desired thickness of a particulate material to a heat tool according to the present invention;

FIG. 3 is a view, similar to that shown in FIG. 2c, and illustrating a bin inverted and emptying step associated with the embodiment of FIG. 1;

FIG. 4 is likewise similar to the view previously shown in FIG. 2d and illustrates the peel-away removal of the hardening part from the mold defining tool surface; and

FIG. 5 is an illustration of an alternate process according to the present invention for concurrently coating a heated and electrically charged structural steel member, the same being drawn in continuous fashion through a bin of resinous material.

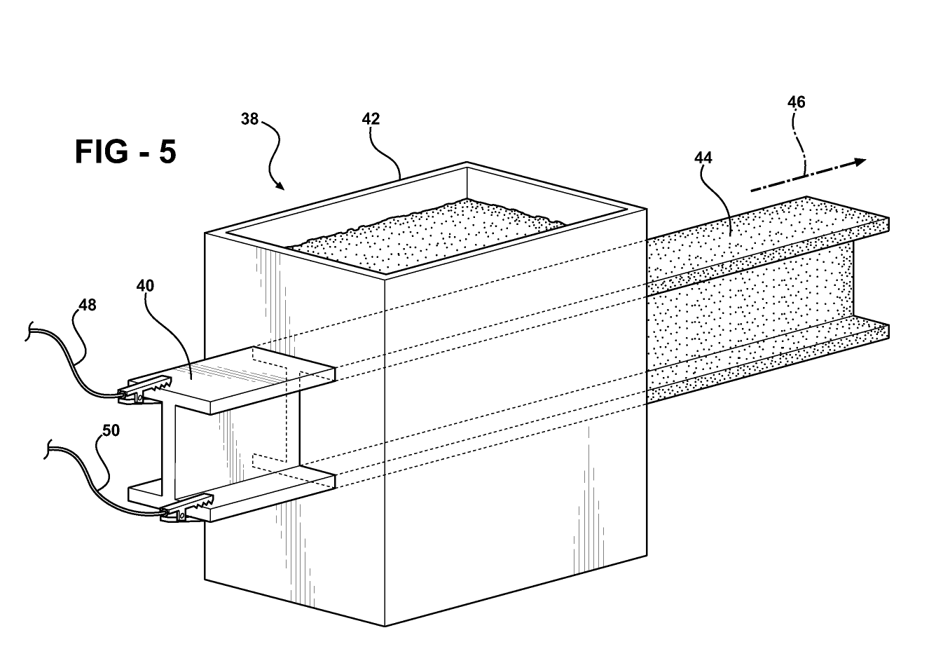

### DETAILED DESCRIPTION OF THE PREFERRED EMBODIMENTS

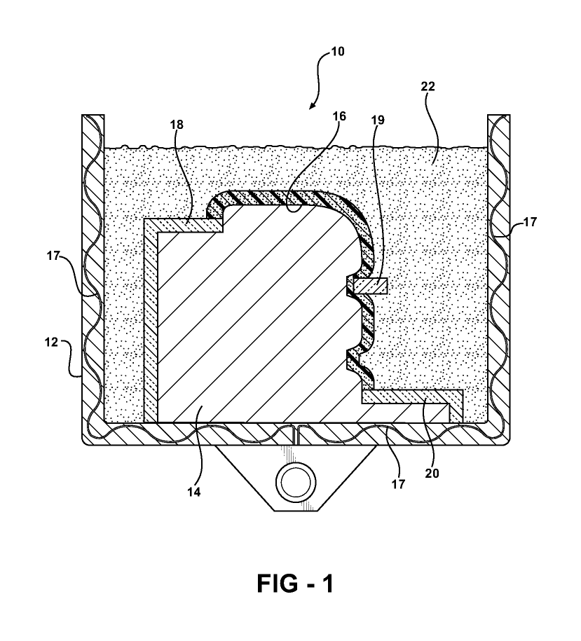

Referring now to the drawing figures, and in particular to FIGS. 1-4, a tool assembly is generally illustrated at 10 according to a first preferred embodiment of the present invention and upon which a polymer or plasticized three-dimensional part is formed. As will be subsequently described, the present invention renders possible the creation of a desired part according to any desired thickness and such as directed to an automotive or other suitable application.

The assembly 10 includes an open interior and volume holding bin 12, within an interior of which is defined a three-dimensional shaped and sculptured article pattern 14. An exposed tool surface 16, which is heated, such as by a suitable heat conducting (e.g. electrical) assembly incorporated into the bin and article 14, and is typically constructed of a metal or other particulate adhering/aggregating surface defined upon the article pattern 14 and corresponding to an area upon which a plasticized coating is to be subsequently applied.

In the preferred application, it is desired that the heat emanate from the exposed and metallic tool surfaces (again typically a polished metal surface) and so that it provides a neat and localized area for initiating aggregation of localized plasticized resin particles, as will be subsequently described. Is it also envisioned that, in addition to heating the exposed article defining surface 16, the exterior walls of the bin may also include heating coils or filaments (see at 17) in order to conduct/convect a desired amount of heat to the particle filled interior of the bin and to facilitate subsequent adherence of volumes of particulate to the exposed article defining surfaces.

Insulated portions 18 and 20 are arranged at specified locations of the tool pattern and in order to define areas to which heated and aggregating plastic does not adhere. It is also contemplated that the location and configuration of the insulating portions can be modified, along with a given adhering pattern surface, and in order to create differently configured parts, and such as including the provision of a ceramic plug or other suitable component, see at 19 in FIG. 1, in order to provide a localized non-adhering area within an otherwise adhering surface portion of the tool surface. Additionally, and although not shown, it is understood that a variety of differently shaped sculpted patterns, not shown, can be secured within the bin interior and in order to create a likewise variety of differently shaped parts.

The plasticized or polymeric article thus created can include such other applications as a plastic shingle, for homes, plastic siding, shower units, Jacuzzi units, swimming pool parts, and hollow panels filled with different materials used in such as third world housing constructions. Other and additional uses of the three-dimensional parts thus created may include, without limitation, such as those as for use in recreation land and sea vehicles.

The bin 12 interior, as will be additionally described in the several succeeding illustrations, is filled with a volume of the plasticized (blank) material in particulate form 22, this filling in and around the three-dimensional sculpted pattern with its exposed heated and part defining surfaces 16. The particulate material includes such as a high polymer or like synthetic material, which exhibits desired thermoplastic properties.

It is also contemplated other types of polymers, polymeric based resins, and the like may also be employed within the scope of the invention and by which a desired three-dimensional quantity of such material in particulate form is caused to aggregate and to adhere to the exposed and attracting surface 16 of the die tool. Additionally, other types of synthetic resins, such further including thermoset resins, can be employed within the scope of the invention and in order to create the desired part from both a structural and material content perspective.

The bin 12 is illustrated in cutaway fashion in FIG. 1, such that the large volume of plasticized (blank) resin 22 is illustrated held within the bin interior. It is contemplated in one embodiment that the particulate adhering surfaces 16 associated with the pattern 14 are preheated to a temperature (such as in a range of 350° F. to 500° F.), while the surrounding ceramic/insulating surfaces 18 and 20 only elevate to a temperature in the range of 100° F. Additionally, and if desired, the particles 22 may be preheated prior to introduction into the bin interior and to facilitate aggregation and formation of a desired thickness and consistency upon the tool surface.

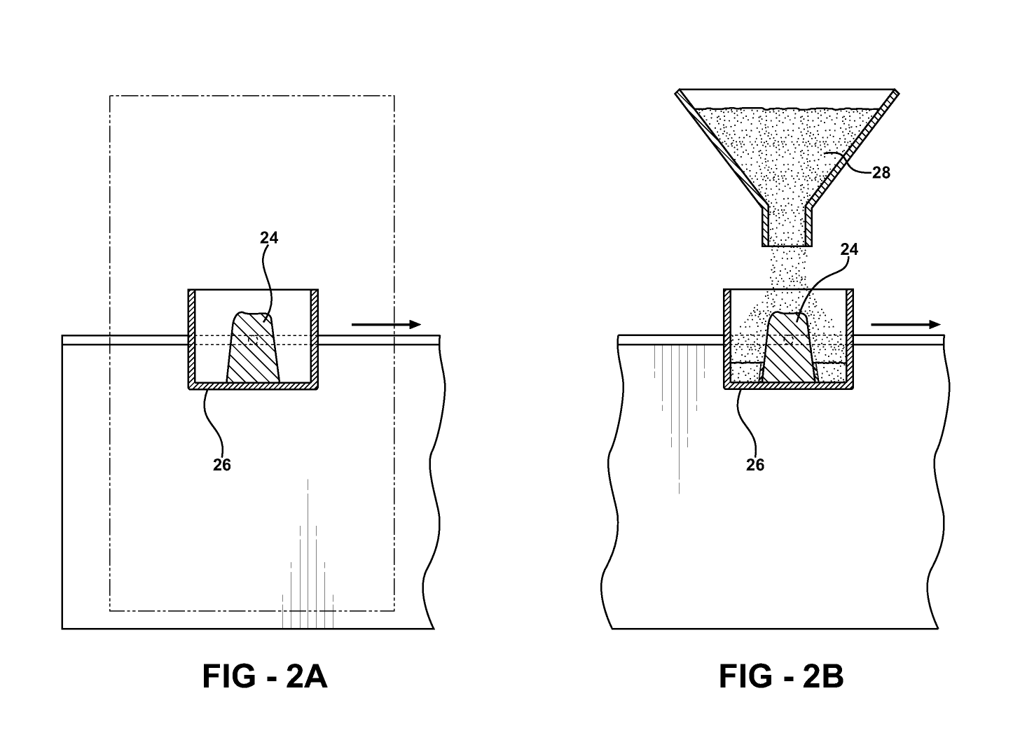

As illustrated with succeeding reference to FIGS. 2a-2d, a multistage process, as will now be explained, is illustrated for adhering a desired thickness of a particulate material to a heat tool according to the present invention. Referring to FIG. 2a, a preheated die or tool surface 24 is located within an open and heated volume holding bin interior 26. As discussed previously, options include heating the particle adhering surfaces of the die pattern tool (and not the insulating portions) to which the particles will adhere, as well as heating the overall interior or ore heating the particles.

Referring to FIG. 2b, a further step includes filling the interior of the bin 26, such as overhead, from a particle filled hopper and such as by which the exposed surfaces of the tool are immersed by the particles. The plasticized content of the particles is again drawn from any of the materials previously described (such as a synthetic plastic) and, as discussed, include any desired particle size. As also discussed, the particles may be preheated to presoftened temperature or may be dumped in a grounded and room temperature state into the bin interior.

At this point, the heated tool surfaces within the bin are exposed and the adhering surface is in contact with the particulate material. The heat conducted through the die tool causes a specified volume of the polymer material within bin to aggregate upon the exposed surface of the die tool, the thickness of such aggregation typically being a variable of the time in which the tool is immersed by the subsequently applied particulate.

Upon completion of a desired aggregating/curing step, referring now to FIG. 2c, the bin 26 is inverted, causing any remaining and non-aggregated particulate 28 to be emptied, and such as through a collection funnel 30 and for recycling to a reconveying line (not shown) for subsequent resupply to a hopper feed for reintroduction in a subsequent bin operation.

Referring to FIG. 2d, the exposed and aggregated part 32 is finally removed from the tool surface and finished according to any known trimming process. The plastic (thermoplastic) part formed upon the die tool is capable of being removed, such as by peeling off, when in the green or thermo-reacting stage and during which it is still flexible and easy to bend.

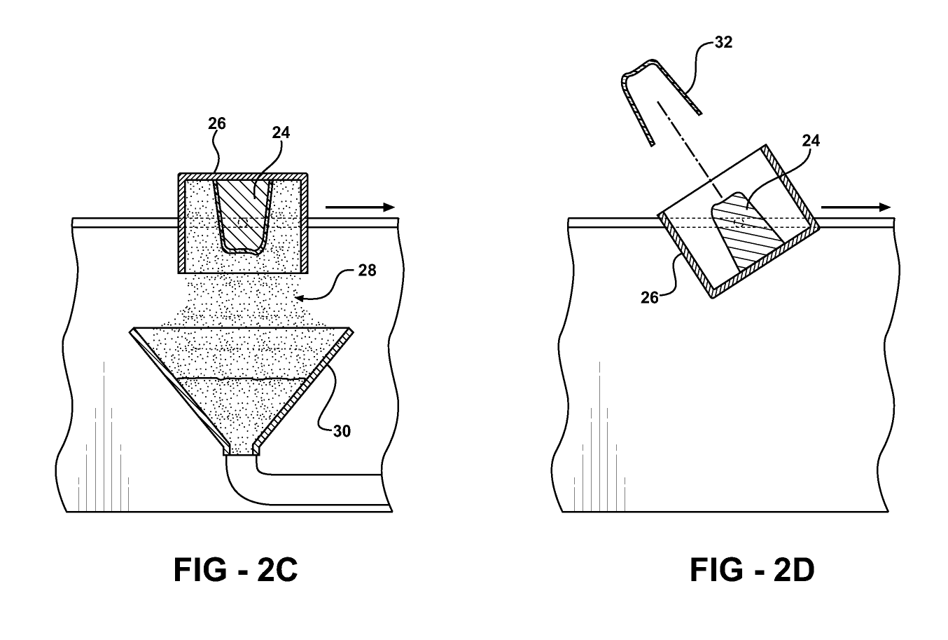

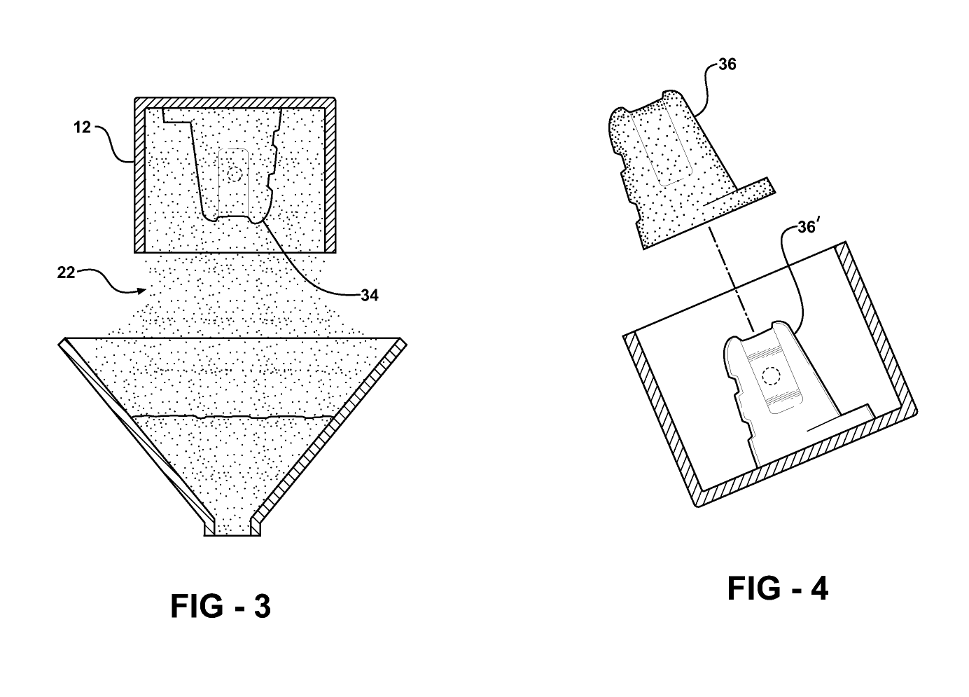

Shown in FIG. 3 is a view similar to that shown in FIG. 2c, and illustrating the bin 12 inverted and emptying associated with the embodiment of FIG. 1. In particular, FIG. 3 illustrates an alternately varied three-dimensional pattern 34 with part defining surfaces and to create a part exhibiting a desired configuration. FIG. 4 is likewise similar to the view previously shown in FIG. 2d and illustrates the peel-away removal of the hardening part, see in phantom at 36′ forming upon the part defining surfaces and removed, at 36, from the mold defining tool surfaces. In a preferred variant, a material thickness of a thermoplastic formed part may exhibit a range of between 0.125″ to 0.500″.

It is again understood that the desired three-dimensional buildup of polymer material upon the die tool is a variable of the preheated temperature of the tool adhering surfaces, as well as potentially that of the particulate bin, and the time period during which the die tool is embedded within the particulate volume filling the bin. Along these lines, parts exhibiting other thicknesses, as well as material properties, can be constructed by altering the temperatures, material content or setting time of the volume of particulate within the bin, all within the scope of one skilled in the art.

Referring to FIG. 7, a further preferred embodiment of the present invention is illustrated at 38, by which the die tool illustrated in the earlier embodiment is substituted by an elongated and structural member 40. The structural member 40 is typically an elongated steel beam, as illustrated, but which may also include such as a metal reinforcing rod or any other suitable elongated and appropriately particulate adhering construction.

The elongate structural member 40 is translated in axially extending fashion through a suitably constructed and configured bin 42 holding a particulate filled 64 material. Heat is again applied, typically to the beam, rod, etc. and prior to the structural member 40 being translated through the aggregate filled bin 42.

A desired volume of particulate material is thereby caused to adhere to the surface of the structural member, see further at 44 and as the elongated member 40 is withdrawn from an opposite end of the bin 42, in the direction further illustrated by arrow 46.

In the above-disclosed manner, the surface of the structural steel member is coated with a desired thermoplastic material, such as for example a rust inhibitor, according to a desired thickness and/or material contact based upon the input parameters (particulate composition, temperature input) of the present invention. It is also understood that the configuration of the bin 42 may be adjusted, such as by sizing apertures on opposite faces thereof, to correspond to the cross-sectional outline of the elongated structural member to be passed therethrough and also in order to minimize a quantity of particulate material which may be spilled or otherwise lost due to the effects of gravity.

As an additional feature, an electrical charge, see contact points 48 and 50, is introduced into the metallic/steel beam, the purpose of the electrical charge being to facilitate and to increase the attraction of the particulate material (electrostatically) to the elongated structural member 40 as it is drawn through the particulate filled bin. To assist in influencing the thermoplastic particles to adhere to the heated and exteriorly charged surfaces of the elongated and progressively drawn member 40, conductive particles (such as metallic flakes) may also be introduced into the thermoplastic matrix, or any other filler material helpful in facilitating the attractive adherence of the thermoplastic granules to the heated and charged exterior of the structural article.

Although not shown, it is also contemplated that the three-dimensional tool of the embodiment of FIGS. 1-4 may also include electrical charging of the polymer adhering surfaces, the purpose for which to facilitate attraction and aggregation of polymer to the tool surface. In either variant, the objective is the creation of a uniform and consistent layer of a molded thermoplastic material, or skin, upon the exposed tool surfaces.

In order to maintain the particulate contents within the bin configured according to this embodiment, it is also contemplated that a vacuum pressure may be introduced within the bin interior and which, in conjunctive operation with the electrostatically charged surface of the workpiece member, facilitates application of a specified coating thickness. The surface of the structural steel member may further be coated with a rust-inhibiting material prior to aggregation of the thermoplastic particles through the drawing process, it also being contemplated that the rust-inhibiting additives can be incorporated into the thermoplastic granule matrix.

Also disclosed is a method of forming a three-dimensional polymer coating upon a die tool, the tool having a specified shape and size and exhibiting an exposed polymer adhering surface corresponding in configuration to a polymeric based part to be created. The method steps include pre-positioning the heated tool within the bin interior and subsequently pouring the plasticized/particulate material over the tool surface. Yet additional steps include adhering/curing, in a temperature and time based fashion, a desired volume and thickness of particulate to the tool surface, inverting the bin to expel remaining and non-aggregated amounts of particulate and, finally, peeling away the completed and hardening part created thereby.

Additional steps include applying a ceramic coating about an extending perimeter of the adhering surface of the tool and/or about at least one aperture defined in the die tool, and in order to prevent aggregating of material thereto. Other steps may include vibrating or shaking the bin during expelling or dumping of the unused particulate and which may simplify subsequent trimming or finishing operations.

Having described our invention, other and additional preferred embodiments will become apparent to those skilled in the art to which it pertains, and without deviating from the scope of the appended claims:

We claim:

1. A method for applying a plasticized coating an elongated structural member in a continuously drawn fashion, comprising the steps of:
translating the elongated structural member, having a specified cross-sectional dimension and exhibiting an exposed polymer adhering surface, through a bin filled with a polymer particulate;
conducting an electrical charge to an exterior surface of the structural member;
attracting and adhering a volume of granule particulate within said bin due at least in part to an electrostatic attraction associated with said exposed and adhering surfaces of the elongated member.

2. The method as described in claim 1, further comprising the step of preheating at least one of the elongated structural member or particulate contents held within said bin.
